(19) United States
(12) Patent Application Publication
(10) Pub. No.: US 2011/0205146 A1
(43) Pub. Date: Aug. 25, 2011

(54) Display Device

(75) Inventors: Matthias Winter, Taipei (TW); Patrick Kromotis, Regensburg (DE)

(73) Assignee: OSRAM Opto Semiconductors GmbH, Regensburg (DE)

(21) Appl. No.: 12/865,847

(22) PCT Filed: Jan. 26, 2009
(86) PCT No.: PCT/DE09/00102

§ 371 Date: Nov. 23, 2010

(30) Foreign Application Priority Data
Jan. 31, 2008 (DE) 10 2008 006 990.6

(51) Int. Cl. G09G 3/36

(52) U.S. Cl. 345/102

(57) ABSTRACT

A display device, in particular a screen unit (6) for a screen (4), is provided which has a backlighting unit (8) for backlighting the screen (4), a polarisation filter (10), which is arranged in an emission direction of the backlighting unit (8) and which at least partially covers the backlighting unit (8), a liquid crystal layer (14), which is arranged on the side of the polarisation filter (10) remote from the backlighting unit (8), and a filter arrangement (16), which comprises at least one colour filter and which is arranged on the side of the liquid crystal layer (14) remote from the backlighting unit (8), wherein the backlighting unit (8) comprises a light-emitting diode (22) which emits blue light, and wherein at least two different phosphors are arranged downstream of the blue-light-emitting light-emitting diode (22), which phosphors absorb the blue light from the light-emitting diode (22) and re-emit light of mutually different colours, which mixes with the blue light from the light-emitting diode (22) to yield white light.

The invention relates to a display device. The invention further relates to a backlighting unit for backlighting a screen. In addition, the invention relates to a screen unit for the screen.

As backlighting for a display device, such as for example a monitor or a screen, for example an LCD screen, cold cathode tubes are regularly used, which emit white light. With these cold cathode tubes the light is produced by cold discharge of mercury and gases. To display colour on the screen, the backlighting light is filtered through colour filters.

The object of the invention is to produce a display device, a backlighting unit for backlighting and a screen unit for a screen which simply and favourably allow particularly good image display.

According to a first aspect of a configuration of the invention, a backlighting unit is provided for backlighting a display device, in particular a screen or a screen unit.

The term “screen” is not limited in this case to the screen of a monitor or of a TV. It may for example also be a large-area display device with an area of 10 m² or more.

The backlighting unit has a light-emitting diode emitting blue light and phosphors emitting green and red, which are arranged and configured such that the blue light from the light-emitting diode excites the green- and red-emitting phosphors.

This particularly simply and favourably makes possible particularly good display by means of the screen, since just one light-emitting diode has to be provided per pixel of the screen and since a particularly broad colour spectrum may be displayed.

According to a second aspect of a configuration of the invention, the backlighting unit is provided for backlighting the display device, for example the screen. The backlighting unit has the light-emitting diode emitting blue light and phosphors emitting green and yellow, which are arranged and configured such that the blue light from the light-emitting diode excites the green- and yellow-emitting phosphors. This particularly simply and favourably makes possible particularly good image display by means of the screen, since just the one light-emitting diode has to be provided per pixel of the screen and since a particularly broad colour spectrum may be displayed.

The phosphors emitting green light are for example from the group of rare earth-doped garnets, silicates, scandanates, thiogallates and/or oxynitrides. The phosphors emitting red light are for example from the group of rare earth-doped silicates, oxynitrides, nitrides and sulfides.

According to a third aspect of a configuration of the invention, a screen unit for the screen is provided. The screen unit comprises the backlighting unit. In addition, the screen unit comprises a polarisation filter, which is arranged in an emission direction of the backlighting unit and which at least partially covers the backlighting unit. A liquid crystal layer is arranged on the side of the polarisation filter remote from the backlighting unit. A filter arrangement comprises at least one colour filter and is arranged on the side of the liquid crystal layer remote from the backlighting unit.

According to a fourth aspect, a display device is provided, in particular a screen unit for a screen, having
a backlighting unit for backlighting the screen,
a polarisation filter, which is arranged in an emission direction of the backlighting unit and which at least partially covers the backlighting unit,
a liquid crystal layer, which is arranged on the side of the polarisation filter remote from the backlighting unit, and
a filter arrangement, which comprises at least one colour filter and which is arranged on the side of the liquid crystal layer remote from the backlighting unit, wherein
the backlighting unit comprises a light-emitting diode which emits blue light, and wherein
at least two different phosphors are arranged downstream of the blue-light-emitting light-emitting diode, which phosphors absorb the blue light from the light-emitting diode and re-emit light of mutually different colours, which mixes with the blue light from the light-emitting diode (22) to yield white light.

In one configuration the phosphors of the backlighting unit are configured such that spectral curves of the phosphors have the greatest possible overlap with the transmission curves of the colour filter. This contributes particularly effectively to the particularly good display by means of the screen.

In a further configuration the screen unit comprises in each case three different colour filters and just one backlighting unit for each pixel of the screen unit. This particularly simply enables simple and favourable configuration of the screen unit.

Exemplary embodiments of the invention are explained in greater detail below with reference to schematic drawings, in which:

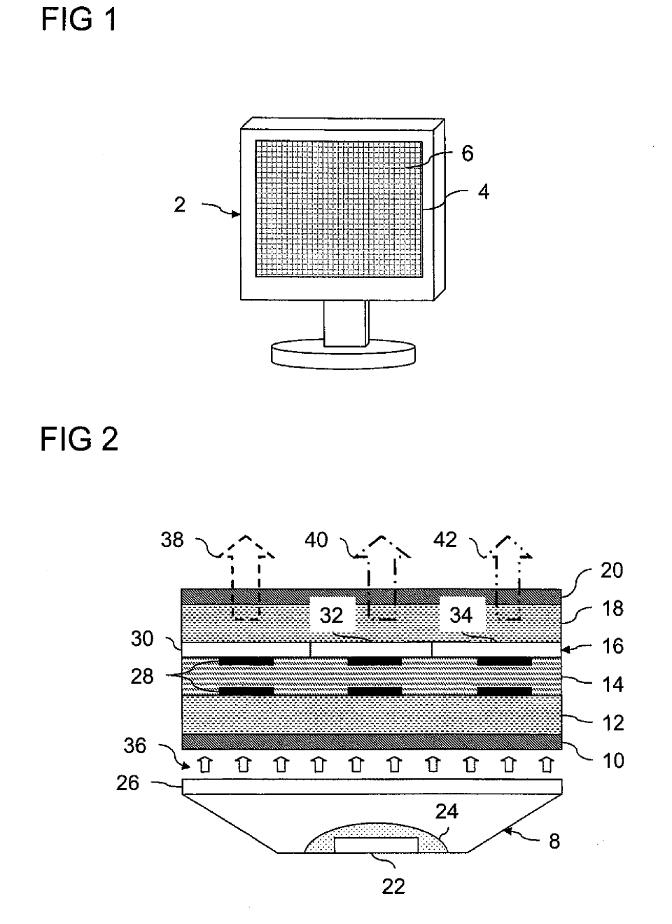

FIG. 1 shows a monitor,

FIG. 2 shows a cross-section through a pixel of a screen unit of the monitor,

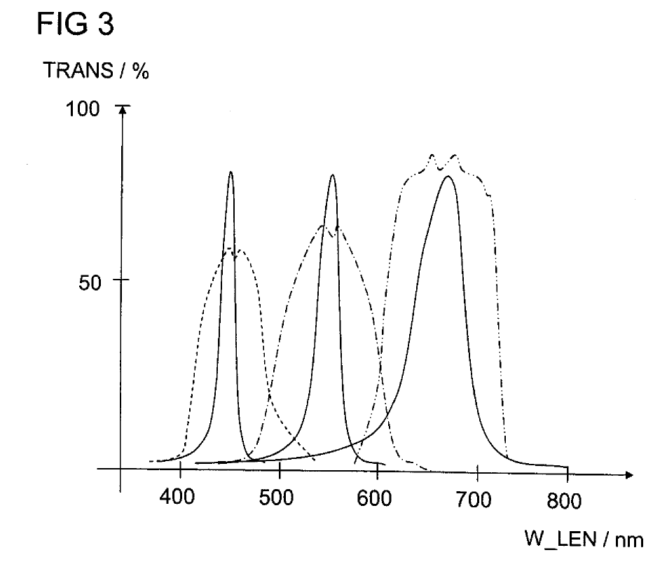

FIG. 3 shows transmission curves of the colour filters and of the backlighting unit.

Identical, similar or identically acting elements are provided with the same reference numerals in the Figures. The Figures and the size ratios of the elements illustrated in the Figures relative to one another are not to be regarded as being to scale. Rather, individual elements may be illustrated on an exaggeratedly large scale for greater ease of depiction and/or better comprehension.

A monitor 2 (FIG. 1) comprises a screen 4. The screen 4 may be produced in one piece and comprise just one screen unit 6. Alternatively, the screen may be of multi-piece construction and comprise a plurality of screen units 6. Each one of the screen units 6 comprises one or more pixels of the screen 4. The monitor 2 is for example an LCD monitor or an LCD television.

Each pixel of the screen 4 (FIG. 2) comprises a backlighting unit 8, a first polarisation filter 10, a first glass sheet 12, a liquid crystal layer 14, a filter layer 16, a second glass sheet 18 and a second polarisation filter 20.

The backlighting unit 8 comprises a light-emitting diode 22 emitting blue light. The light-emitting diode 22 emitting blue light is embedded in a potting compound 24. The potting compound 24 comprises phosphors. The phosphors are excited by the blue light from the light-emitting diode 22. The excited phosphors in part emit green and in part red light. Alternatively, the phosphors emit green and yellow light. In this context, this means that at least two different types of phosphors are embedded in the potting compound 24 and that these in each case emit differently coloured light. The light-emitting diode 22 and the phosphors are configured and arranged such that the blue light from the light-emitting diode 22 and the green and red or green and yellow light from the phosphors mixes to yield white light 36, which is then emitted by the backlighting unit 8.

The backlighting unit 8 may comprise a cover 26. In the emission direction of the backlighting unit, the cover 26 is followed by the first polarisation filter 10. The first polarisation filter 10 is provided for filtering the light emitted by the light-emitting diode 22. The polarised light penetrates the first glass sheet 12, which together with the second glass sheet 18 embeds the liquid crystal layer 14 and the filter layer 16. The liquid crystal layer 14 is coupled with electrodes 28. The crystals of the liquid crystal layer 14 are oriented between the corresponding electrodes in accordance with the voltage applied to the electrodes 28, such that, as a function thereof, the light emitted by the backlighting unit 8 may pass virtually unimpeded through the liquid crystal layer 14 or is attenuated accordingly.

The filter layer 16 preferably comprises a blue filter 30, a green filter 32 and a red filter 34. Blue, green or red light 38, 40, 42 of different intensities is thus allowed through in the emission direction downstream of the corresponding filter, depending on the voltage at the electrodes. The blue, green and red light 38, 40 42 may thus be differently mixed at the corresponding electrodes depending on the voltage, which allows display of a wide range of colours. The second glass sheet may be covered with the second polarisation filter 20.

The phosphors in the potting compound 24 are preferably selected such that the light spectrum emitted by them in each case has the greatest possible overlap with transmission curves (FIG. 3) of the colour filters. In FIG. 3, for example, the transmission curve of the blue filter 30 is shown by a dashed line, that of the green filter 32 by a dash-dotted line and that of the red filter 24 by a dash-dot-dotted line. The spectra of the emitted light from the light-emitting diode 22 emitting blue light and the phosphors lie centrally in the corresponding transmission curves of the colour filters. Preferably, the area enclosed by the spectral curves of the phosphors and the light-emitting diode 22 has the greatest possible overlap with the corresponding areas enclosed by the transmission curves. This allows particularly good light yield and particularly good image display over a particularly wide colour gamut. This contributes to particularly good display of an image by means of the monitor 2. In addition, use of the light-emitting diode 22 with the phosphors is particularly simple and favourable for the backlighting 8, since just one light-emitting diode has to be activated for each pixel. In addition, the phosphors may be individually adapted to different colour filters. “Greatest possible” may here mean that the enclosed areas display an overlap zone which has an area of at least 50% of the total area of the areas enclosed by the two spectral curves. Preferably the proportion amounts to at least 75% of the total area.

The invention is not restricted by the description given with reference to the exemplary embodiments. Rather, the invention encompasses any novel feature and any combination of features, including in particular any combination of features in the claims, even if this feature or this combination is not itself explicitly indicated in the claims or exemplary embodiments.

This patent application claims priority from German patent application DE 102008006990.6, whose disclosure content is hereby included by reference.

1. A display device, in particular a screen unit for a screen, comprising:
a backlighting unit for backlighting the screen;
a polarisation filter, which is arranged in an emission direction of the backlighting unit and which at least partially covers the backlighting unit;
a liquid crystal layer, which is arranged on the side of the polarisation filter remote from the backlighting unit; and
a filter arrangement, which comprises at least one colour filter and which is arranged on the side of the liquid crystal layer remote from the backlighting unit,
wherein the backlighting unit comprises a light-emitting diode which emits blue light, and
wherein at least two different phosphors are arranged downstream of the blue-light-emitting light-emitting diode in the direction of emission thereof, which phosphors absorb the blue light from the light-emitting diode and re-emit light of mutually different colours, which mixes with the blue light from the light-emitting diode to yield white light.

2. The display device according to claim 1, wherein phosphors re-emitting in green and red are arranged downstream of the light-emitting diode emitting blue light.

3. The display device according to claim 1, wherein phosphors re-emitting in green and yellow are arranged downstream of the light-emitting diode emitting blue light.

4. The display device according to claim 1, wherein phosphors re-emitting in green, red and yellow are arranged downstream of the light-emitting diode emitting blue light.

5. The display device according to claim 1, wherein the phosphors of the backlighting unit are configured such that spectral curves of the phosphors have the greatest possible overlap with the transmission curves of the colour filter.

6. The display device according to claim 1, comprising:
a plurality of pixels, wherein each pixel of the screen unit in each case comprises three different colour filters and just one backlighting unit.

7. The display device according to claim 1, comprising a plurality of pixels, wherein one light-emitting diode emitting blue light is assigned on a one-to-one basis to each pixel.
